(19) United States
(12) Patent Application Publication
(10) Pub. No.: US 2025/0344222 A1
(43) Pub. Date: Nov. 6, 2025

(54) METHODS AND SYSTEMS FOR DCI AND TCI SCHEMES FOR BEAM MANAGEMENT IN MASSIVELY DISTRIBUTED MIMO

(71) Applicant: INTERDIGITAL PATENT HOLDINGS, INC., Wilmington, DE (US)

(72) Inventors: Kyle Jung-Lin PAN, Saint James, NY (US); Patrick SVEDMAN, Stockholm (SE); Guodong ZHANG, Woodbury, NY (US); Allan Yingming TSAI, Boonton, NJ (US); Arman SHOJAEIFARD, London (GB)

(73) Assignee: INTERDIGITAL PATENT HOLDINGS, INC., Wilmington, DE (US)

(21) Appl. No.: 18/993,323

(22) PCT Filed: Jul. 11, 2023
(86) PCT No.: PCT/US2023/027402

§ 371 Date: Jan. 10, 2025

Related U.S. Application Data
(60) Provisional application No. 63/388,123, filed on Jul. 11, 2022.

(51) Int. Cl. H04W 72/232; H04L 5/00

(52) U.S. Cl. CPC H04W 72/232; H04L 5/0044

(57) ABSTRACT

Several methods of providing downlink control information (DCI) and transmission configuration indication (TCI) for massively distributed MIMO and massive TRPs are described herein. For example, methods of Hybrid-DCI mechanism for massively distributed MIMO are described herein. For example, methods for Hierarchical-DCI mechanism for massively distributed MIMO are also described herein. For example, methods of enhanced transmission configuration indication TCI mechanism for massively distributed MIMO are also described herein. For example, methods of dynamic switching for Single-DCI and Multi-DCI for massively distributed MIMO are also described herein. For example, methods of adaptation for DCI/TCI mechanism for massively distributed MIMO are also described herein.

### CROSS-REFERENCE TO RELATED APPLICATIONS

This application claims the benefit of U.S. Provisional Application No. 63/388,123 filed Jul. 11, 2022, the contents of which are incorporated herein by reference

### BACKGROUND

Due to WTRU mobility a WTRU may move across multiple transmit reception point (TRPs) and may be connect to multiple TRPs at the same time. Current DCI mechanisms may be developed without consideration of massive TRPs. In addition, transmission configuration indication (TCI) framework may be developed without consideration of massive TRPs. Due to mobility and massive TRPs, current designs for downlink control information (DCI) for 2-TRP and unified TCI for single TRP may not be sufficient or optimum and need to be enhanced. In addition, extension to massive TRPs may be required to support massively distributed MIMO deployment. There is also a need for unified TCI to be extended to a massive TRPs scenario. There is also a need to provide all DCI/TCI information that is needed for massive TRPs, while reducing signaling overhead and enhancing coverage for control.

### SUMMARY

A method and WTRU for switching between a multiple DCI/TCI schemes is disclosed. The WTRU will send capabilities including resource allocation handling capabilities to a network. The WTRU will receive first configuration information for a first DCI/TCI scheme, and use the first DCI/TCI scheme to receive an allocation of resources for receiving physical downlink shared channel (PDSCH) transmissions from multiple transmission reception points (TRPs). Then the WTRU will receive second configuration information for a second DCI/TCI scheme and switch from the first DCI/TCI scheme to the second DCI/TCI scheme to receive an allocation of resources for receiving PDSCH transmissions from the multiple TRPs. The first DCI/TCI scheme may be a hierarchical-DCI/TCI scheme, and the second DCI/TCI scheme may be a hybrid-DCI/TCI scheme. The hierarchical-DCI/TCI scheme may include the WTRU: decoding a primary PDCCH (pPDCCH) transmission from one TRP of the multiple TRPs, obtaining common resource allocations for TRPs of the multiple TRPs, decoding secondary PDCCH (sPDCCH) transmissions and obtaining different TCIs for different TRPs, and detecting a PDSCH transmission using a common resource allocation (CRA) and beams indicated by the different TCIs for different TRPs of the multiple TRPs. The hybrid-DCI/TCI scheme may include the WTRU: decoding a group PDCCH (gPDCCH) transmission from one TRP of the multiple TRPs, obtaining common resource allocations (CRA) and different TCIs for a TRP group, decoding a gPDCCH transmission from multiple TRP groups and obtaining different TCIs for TRPs, and detecting a PDSCH transmission using CRA per group of TRPs and different beams indicated by the different TCIs for the group of TRPs. The switching from the first DCI/TCI scheme to the second DCI/TCI scheme may be based on a MAC CE. The WTRU may transmitting a PUSCH transmission to TRPs using combined control information and TCI information obtained for all TRPs using the second DCI/TCI. Alternatively the first DCI/TCI scheme is a multi-DCI/TCI scheme, or a the first DCI/TCI scheme is a single-DCI scheme.

Several other methods of providing downlink control information (DCI) and transmission configuration indication (TCI) for massively distributed MIMO and massive TRPs are described herein. For example, methods of Hybrid-DCI mechanism for massively distributed MIMO are described herein. For example, methods for Hierarchical-DCI mechanism for massively distributed MIMO are also described herein. For example, methods of enhanced transmission configuration indication TCI mechanism for massively distributed MIMO are also described herein. For example, methods of dynamic switching for Single-DCI and Multi-DCI for massively distributed MIMO are also described herein. For example, methods of adaptation for DCI/TCI mechanism for massively distributed MIMO are also described herein.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of a single PDCCH carrying DCI for all TRPs resource allocation scheme;

FIG. 3 is an example of a hybrid-DCI scheme, or a TRP group-based single/multi-DCI scheme;

FIG. 4 is an example of method of performing a hybrid-DCI mechanism;

FIG. 5 is an example multi DCI scheme;

FIG. 6 is an example of a hierarchical-DCI scheme showing pDCI and sDCI;

FIG. 7 is an example method of performing a hierarchical-PDCCH scheme;

FIG. 8 is an example of a hierarchical-DCI scheme showing G-pDCI+sDCI;

FIG. 9 is an example method of performing of hierarchical-PDCCH to support partially overlapped resource allocations;

FIG. 10 is an example method of performing a hierarchical-PDCCH scheme;

FIG. 11 is another example method of performing a hierarchical-PDCCH scheme;

FIG. 12 is another example of method for performing fast TCI indication;

FIG. 13 is an example scheme for using TCI pairs for M TRPs;

FIG. 14 is an example scheme for using TCI pairs for M TRPs using TRP grouping;

FIG. 15 is an example scheme for using TCI pairs for M TRPs with TRP grouping 2;

FIG. 16 is an example method for TCI for massively distributed MIMO;

FIG. 17 is an method of performing DCI scheme switching;

FIG. 18 is an example method of performing an adaption for DCI/TCI scheme; and

FIG. 19 is another example method of performing an adaption for DCI/TCI scheme.

### DETAILED DESCRIPTION

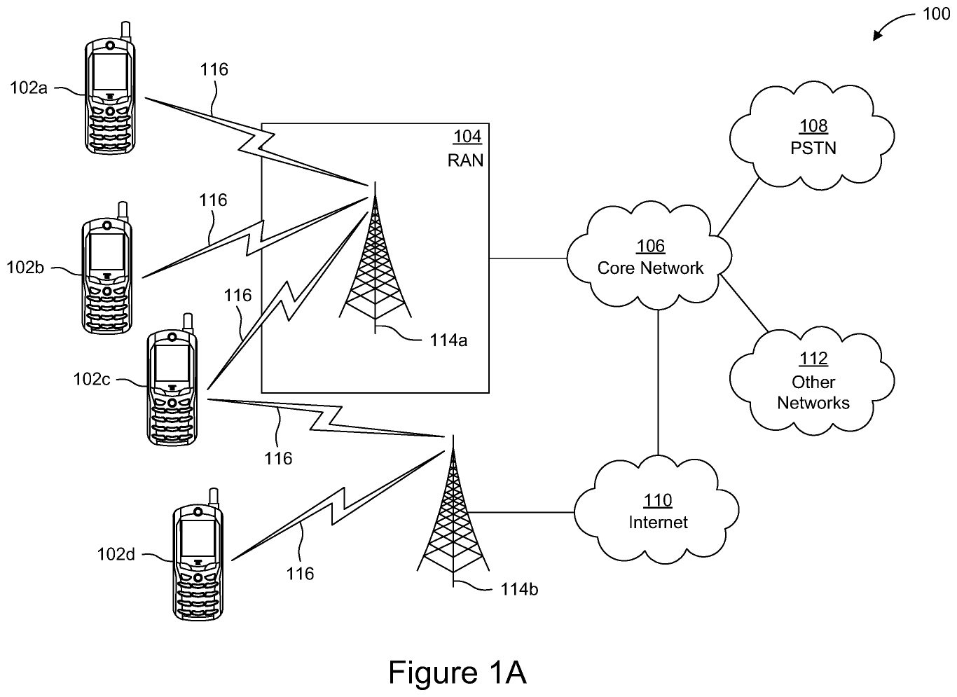

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b,102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

“Massive TRPs” refers to large number of TRPs. “Massive MIMO” refers to large number of antennas per TRP. “Distributed massive MIMO” refers to multiple TRPs with a large number of antennas per TRP. “Massively distributed MIMO” refers to large number of TRPs, i.e., “massive TRPs”.

The following abbreviations and acronyms may be referred to herein.
BFD-RS Beam Failure Detection-Reference Signal
BFR Beam Failure Recovery
BFRQ Beam Failure Recovery Request
BLER Block Error Rate
BFI Beam Failure Instance
CORESET Control Resource Set
CRI CSI-RS Resource Index
CSI-RS Channel State Information-Reference Signal
DCI Downlink Control Information
JT Joint Transmission
L1-RSRP Layer 1-Reference Signal Received Power
L1-SINR Layer 1-Signal to Interference and Noice Ratio
NBI-RS New Beam Identification-Reference Signal
NW Network
PDCCH Physical Downlink Control Channel
RS Reference Signal
SSBRI SSB Resource Index
TCI Transmission Configuration Indication
TDD Time Division Duplex
TRP Transmission and Reception Point

In 5G NR, TCI framework has been introduced. Unified TCI for single TRP may be supported. For non-unified TCI, only two TRP operation is supported and there is no support of coherent joint transmission among TRPs. Further, the TCI Framework may only support up to 2 TCI states indication with one TCI code point. The TCI Framework also supports frequency range for FR1 and FR2.

For Multi-TRP operation, dynamic TRP selection may be supported. Also mobility measurements for multi-beam/multi-TRP deployments up to 64 SSBs per cell may be supported. Multi-TRP transmission of PDSCH for eMBB may also be supported. In addition, multi-TRP diversity for URLLC is supported. Multi-TRP operation is based on 2 TRPs may also be supported. Also, Inter-cell multi-TRP operation may be supported. Also, inter-cell multi-TPR operation without handover may be supported. Multi-TRP repetition of PDCCH, PUCCH and PUSCH may also be supported.

CSI-RS framework may support CSI interference measurement based on ZP-CSI-RS (e.g., CSI-IM resources) and/or NZP-CSI-RS resources. A Type-II codebook for high-resolution CSI feedback may also be supported. Enhancements on Type-II codebook may also be supported. CSI enhancement for multi-TRP non-coherent joint transmission (NCJT) may also be supported.

In a highly dense network, a WTRU may connect with massive TRPs in massively distributed MIMO scenarios. A WTRU may receive data via DL data channel e.g., PDSCH from massive TRPs, or may transmit data via UL data channel e.g., PUSCH to massive TRPs. Such transmission or reception may be either coherent or non-coherent. A WTRU may first receive downlink control information (DCI) via a DL control channel transmission e.g., PDCCH from one or more TRPs.

When a DCI is transmitted from a single TRP to enable data reception from or transmission to massive TRPs, DCI payload size may be large if additional bits are needed in DCI to support large number of TRPs, for instance duplicated fields (e.g., TCI fields) or field extensions (e.g., for supporting a larger number of TCI codepoints). As number of TRPs increases, so does DCI payload size. Increased DCI payload size may decrease performance of PDCCH and reduce coverage of DCI. In massively distributed MIMO deployment, single DCI scheme may require additional bits to support large number of TRPs. Multi-DCI scheme may require additional PDCCHs to support large number of TRPs. Trade off between single DCI and multi-DCI schemes may be considered.

A proposed WTRU may be configured to perform an adaptation mechanism for multiple DCI/TCI scheme operation and procedure for massively distributed MIMO is also proposed herein. A DCI/TCI scheme may be adaptive to optimize the spectrum efficiency, minimize the signaling overhead and enable the scheduling and operation flexibility of system. A DCI/TCI scheme may be adapted between multiple DCI/TCI schemes such as single-DCI scheme, multi-DCI scheme, hybrid-DCI scheme and hierarchical DCI scheme. A DCI/TCI adaptation may be determined based on certain criteria including but not limited to transmission type, resource allocation type and resource overlap type. The transmission type may be coherent or non-coherent joint transmission. Resource allocation type may be overlap or non-overlap resources. Resource overlap type may be full overlapping or partial overlapping. A WTRU may be configured with multiple DCI schemes according to the embodiments proposed herein. Resources may be allocated for PDSCH transmission for TRPs.

A WTRU may report capability including resource allocation capability. If a transmission type is determined to be non-coherent joint transmission, the resource allocation type is further determined. If resource allocation type is determined to be overlap type, then resource overlap type is further determined. If the determined resource overlap type is partial overlap, then a Hybrid-DCI scheme is activated and enabled (e.g., in MAC CE). The WTRU will decode the gPDCCH from one TRP per TRP group. Then the WTRU will obtain common resource allocations but different TCIs (via gDCI) for TRP group, decode gPDCCH from multiple TRP groups and obtain different TCIs.

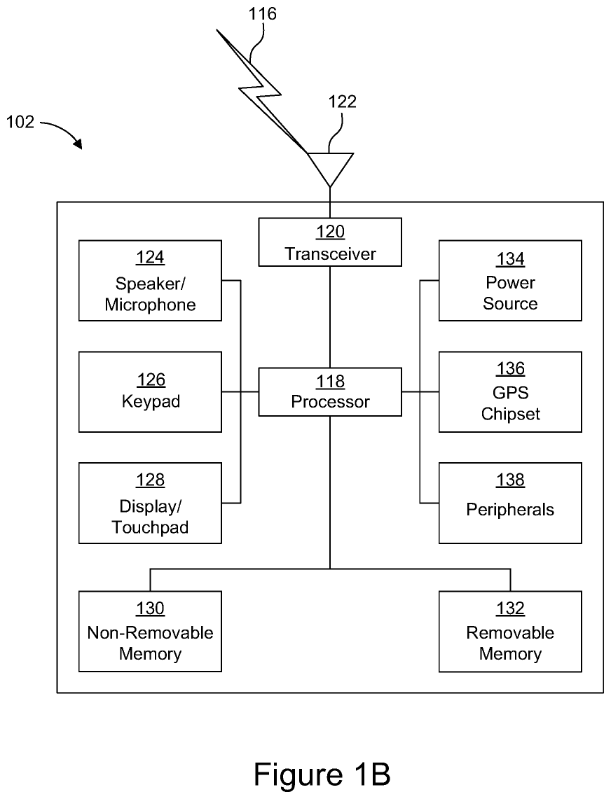

A single-DCI resource allocation scheme 200 for a multi TRP 210 scenario is depicted in FIG. 2.

In FIG. 2, a single PDCCH carrying DCI 220 for all TRPs 210, 240 is transmitted from one of the TRPs 240 to the WTRU 230. The single-DCI 220 contains control information to detect PDSCH or transmit PUSCH for large number of TRPs.

Some common control field may be shared among massive TRPs to reduce DCI payload size. For example, the common control fields may be a resource allocation field. In an example, for single DCI 230, same free-time resources can be allocated, and different layers can be transmitted from different TRPs. In addition, some control fields may be made common for certain situations. For example, modulation and coding (MCS) may be made common at the cost of less flexibility for link adaptation. By doing so, the DCI payload size may be reduced, but the system flexibility may be reduced.

For coherent operations, resource allocation may be common, therefore in this scenario the control field for a resource allocation may be common for all TRPs. On the other hand, for non-coherent operations, resource allocation may not necessarily be common, therefore in this scenario the control field for a resource allocation may not be common for all TRPs. Thus, scenario dependent DCI operation may be considered and used depending on whether the operations are coherent or non-coherent. DCI operation mode may be configured by RRC. Alternatively, multiple DCI operation modes may be configured by RRC and exact DCI operation mode to use may be activated or indicated by MAC CE or DCI.

Two types of DCI for massively distributed MIMO may be utilized, one type of DCI (say type A DCI) may be used for low payload DCI and another type DCI (say type B DCI) may be used for high payload DCI. For coherent operations, type B DCI may be used. while for non-coherent operations, both type A and type B DCls may be used depending on scenarios and trade-offs. Two DCI formats may be developed for type A and type B DCIs for massively distributed MIMO.

Furthermore, scalable DCI may be used. Depending on number of TRPs that WTRU is connected to, DCI may be large or small. However, if DCI is very large, the performance of the PDCCH may suffer. Therefore, a maximum number of TRPs that WTRU can connect to may be limited. This number M may be configurable. The maximum number of TCI states per TCI codepoint or number of CORESET pools may be determined based on the maximum number of TRPs. As an example, in extracting a subset of TCI states defined in PDSCH-Config and activating/deactivating specific TCI States, a list (a subset) of TCI states to activate/deactivate is configured by the bitmap. If a bit in a specific location is set to be ‘1’, the TCI state mapped to the position of the bit is actived. If the bit is set to be ‘0’, the TCI state mapped to the position of the bit is deactivated. The list of bit position that are set to be ‘1’ is assigned to a table, or codepoint.

TRP grouping may be used. Within the same TRP group, a single DCI may be used. CORESET or CORESET pool may be associated with each TRP group. Across TRP groups, multiple DCIs may be used. Maximum M TRPs may be used in a TRP group to support reasonable DCI payload size. There may be N TRP groups that a WTRU may be connected to. Thus, M×N TRPs may be supported for a WTRU connection in massively distributed MIMO. There may also be a maximum number of single DCIs allowed. This number may correspond to N and may also be configurable. TRP grouping may be based on type of TRPs, DCI mechanism, control transmission scheme (e.g., single-DCI, multi-DCI, hybrid-DCI, hierarchical-DCI, the variants of above, etc), DCI payload size, data transmission scheme (e.g., coherent, or non-coherent joint transmission, diversity transmission), WTRU measurements including RSRP, WTRU capability, QoS requirements such as reliability, WTRU mobility, or the like. WTRU may report some or all the above to gNB to assist TRP grouping. WTRU may also perform autonomous TRP grouping based on the available information described above.

A hybrid DCI scheme may be developed and utilized. A hybrid DCI scheme may support single DCI scheduling multiple TRPs and multiple DCI scheduling multiple TRPs (or TRP groups). A Hybrid DCI scheme may achieve a trade-off between DCI payload size and performance.

Two operation modes may be supported for massively distributed MIMO. Mode 1 may support fixed or configurable number of TRPs for each WTRU connection. Mode 2 may support a variable or dynamic number of TRPs for each WTRU connection. The maximum number of TRPs for a WTRU connection may be (pre-) configured based on DCI operation mode. In addition, the maximum number of TRPs for WTRU connection may be determined by or based on DCI mechanism, control transmission scheme, DCI payload size, data transmission scheme (e.g., coherent or non-coherent joint transmission, diversity transmission), measurements including RSRP, WTRU capability, QoS requirements such as reliability, WTRU mobility, or the like.

In mode 1 operation, if a control field or codepoint indicates a TRP index, CORESET index, CORESET Pool Index or the like, and corresponding TCI states, then a WTRU may receive a PDSCH from the indicated TRPs and beam of TCI states in massively distributed MIMO. For those TRP not indicated, a WTRU may maintain the same TRP and same beam for PDSCH reception. TCI updates may occur only when TCIs are indicated. If TCIs are not indicated, the same TCI states may be reused. In mode 2 operation, if a control field or codepoint indicates TRP index and corresponding TCI states, then a WTRU may receive a PDSCH transmission from the indicated TRPs and/or a beam of TCI states in massively distributed MIMO. But for those TRPs not indicated, a WTRU may remove those TRPs and beams for PDSCH reception. If TCI are not indicated, the corresponding TCI states may not be used. The set of TRPs and TCI states may be indicated in a DCI and used at a WTRU. Similarly, the operation modes may also be applied for uplink. Furthermore, operation mode may be applied for DL and UL either simultaneously, separately, or jointly, which may also be configured. Activated TCI states may be associated with TRPs. A TRP may also be identified by activated TCI states implicitly.

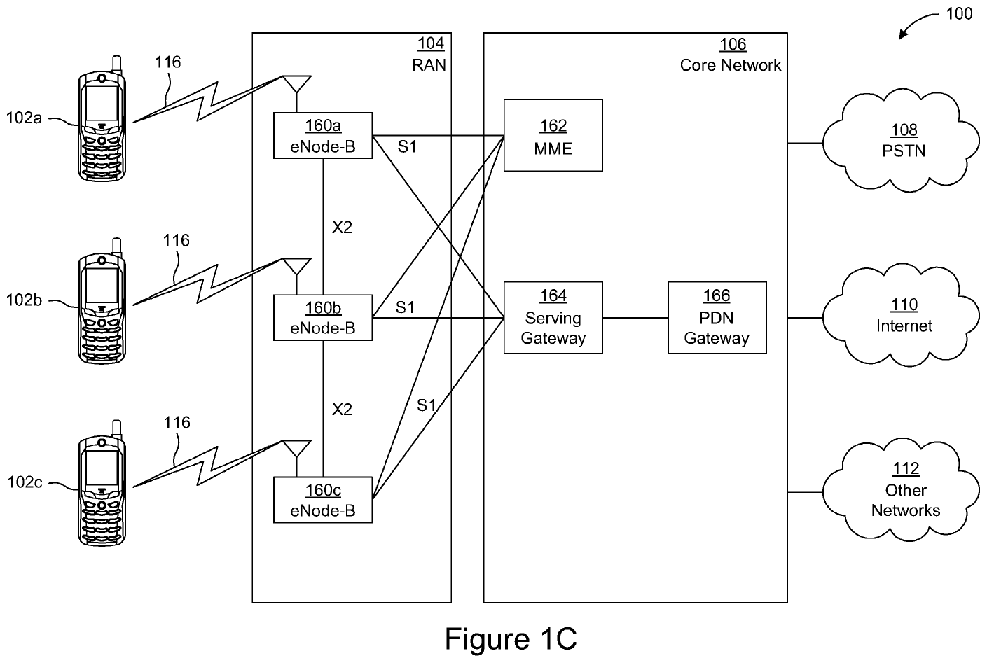

Example method of hybrid-DCI mechanism is depicted in FIG. 3. Even for fully overlapped resources, if a number of TRPs is large, then a DCI size needs to increase significantly, or scheduling flexibility may be restricted which results in coverage and performance degradation. In addition, the number of TRPs which perform joint transmission (either coherent or non-coherent joint transmission) or diversity transmission (e.g. by TDM, FDM, SDM of TRPs or point selection) may vary. This could result in a variable DCI size. Therefore, there may be a limitation or restriction on the number of TRPs when using single-DCI. But when we limit a number of TRPs, we may not support many TRPs. Thus, we may introduce a hybrid DCI scheme that utilizes the joint designs of a single-DCI scheme and multi-DCI scheme.

As shown in FIG. 3, three TRPs are formed a TRP group in each arc. Each TRP group may jointly transmit a PDCCH using single-DCI scheme. This PDCCH is called group PDCCH or gPDCCH. There are four TRP groups, therefore three gPDCCHs are transmitted. Multi-gPDCCH scheme is used across multi-TRP groups.

One solution may be to use common TRP group information to achieve lower overhead. For each TRP group, the freq and/or time resources may be common, a group PDCCH or gPDCCH may be used to carry the control information for each TRP group. Multiple gPDCCHs may be used to carry control information for multiple TRP groups.

At least two types of DCI formats may be used and-one DCI format is used and optimized for large DCI payload to support a large number of TRPs, and the other DCI format is used for regular DCI payload. Which DCI format to use may depend on the number of TRPs to connect with and WTRU capability.

TRP dropping rule may be used. In case that the number of TRPs to connect with exceed the (pre-)configured threshold, some of TRPs may be dropped. The dropping of a TRP may be determined by a WTRU. Dropping of TRPs may be based on measurements, priority, or the like. Measurement may be based on RSRP for example. Other formats and parameters may also be used to measure the signal power or to make decisions to drop TRPs. Priority may be assigned to TRPs. Different types of TRPs may be deployed and assigned with different priorities. For example, some TRPs may employ traditional MIMO techniques (e.g., antenna arrays that are linear, planar, circular, etc.) and other TRPs may employ holographic MIMO technique. In one example, holographic MIMO is facilitated by ultra-thin, extremely large, and nearly continuous surfaces that incorporate reconfigurable and sub-wavelength-spaced antennas and/or metamaterials. Higher priority may be assigned to holographic TRPs and lower priority may be assigned to traditional TRPs, or vice versa. When a TRP is dropped, a WTRU might not monitor a PDCCH for the CORESET associated with the TRP that is dropped and might not expect to receive PDSCH or transmit PUSCH for dropped TRP. Dropping a TRP may imply deactivating a TCI state (corresponding to the TRP) from one or more CORESETs or TCI codepoints, or to deactivate a CORESET and/or search space set associated with the dropped TRP.

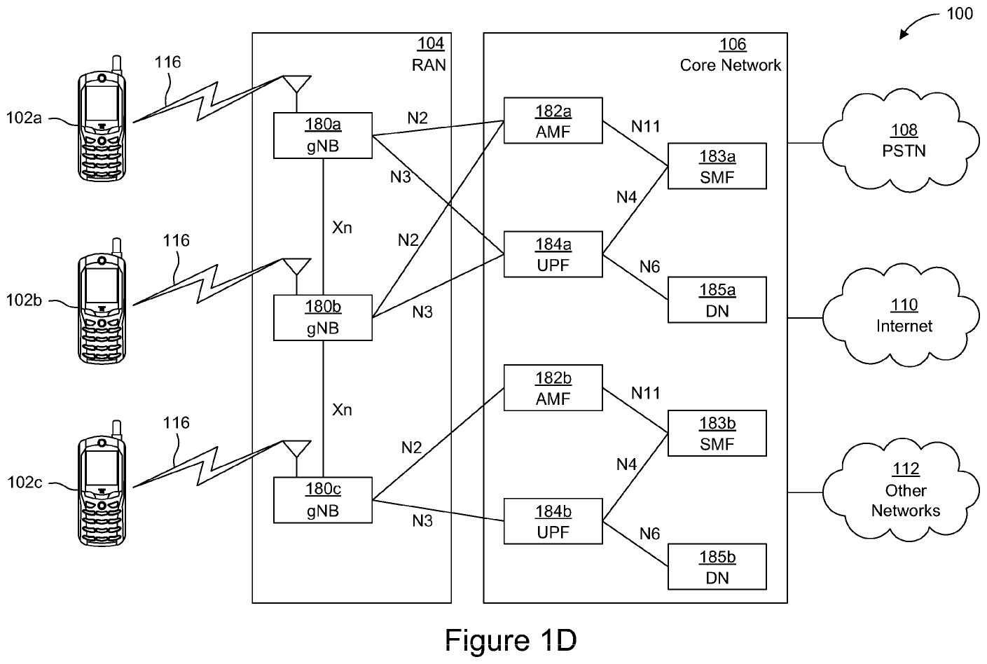

An example procedure 400 for receiving a resource allocation using a hybrid-DCI mechanism is depicted in FIG. 4. A WTRU may be configured for hybrid DCI mechanism, at 410. A WTRU may be configured with CORESET and/or CORESET pool for hybrid DCI, at 420. Such configuration may be for TRP group. A WTRU may monitor PDCCH for DCI in search space of CORESET associated with each TRP group, at 430, and decode PDCCH for each TRP group and for all TRP groups accordingly, at 440. A WTRU may combine all or some DCIs that are decoded in PDCCHs to obtain control information for all TRPs, at 450. A WTRU may then detect and demodulate a PDSCH using combined control information obtained for all TRPs, at 460.

Alternatively, at 450, DCI combination may be based on an indicator, the same HARQ process, the same resource allocation e.g., time domain resource allocation (TDRA), or based on PDCCH linkage via a RRC configuration.

Methods of hierarchical-DCI mechanism for massively distributed MIMO, or massive TRPs are discussed herein. In the case of a multi-DCI mechanism, a PDCCH transmission carrying a DCI is sent from each TRP. In this case there are multiple PDCCHs carrying multiple DCIs transmitted from multiple TRPs. Each DCI carries control information for each TRP including resource allocation information. Resource allocation information may be common for all TRPs. If resource allocation information is common for all TRPs, then the same resource allocation information is repeated in every DCI which is not efficient for resource utilization. In massively distributed MIMO deployment, a massive number of TRPs are used. The same resource allocation information is repeated in every DCI for the massive number of TRPs, which significantly decrease resource utilization efficiency.

In a highly dense network. a WTRU may connect with a massive TRP in massively distributed MIMO scenarios. A WTRU may receive data via DL data channel e.g., PDSCH from massive TRPs, or may transmit data via UL data channel e.g., PUSCH to massive TRPs. Such transmission or reception may be either coherent or non-coherent A WTRU may first receive downlink control information (DCI) via DL control channel e.g., PDCCH from one or more TRPs. When a DCI is transmitted from multiple TRPs to enable data reception from, or transmission to, massive TRPs, a number of DCIs may be large. As the number of TRPs increases, so does a number of PDCCHs. An increased number of PDCCHs may increase blind decoding attempts and decoding complexity as well as PDCCH blocking.

For non-coherent joint transmission using multi-DCI freq-time resource may be fully overlapped, and in such scheme, a primary DCI or pDCI may carry overlapped information. In this case, it may not be efficient to repeat resource allocation info in every DCI of multi-DCI. This may cause the waste of resource and increase overhead. For multi-DCI, to enhance PDCCH performance and reduce DCI payload, solutions are needed.

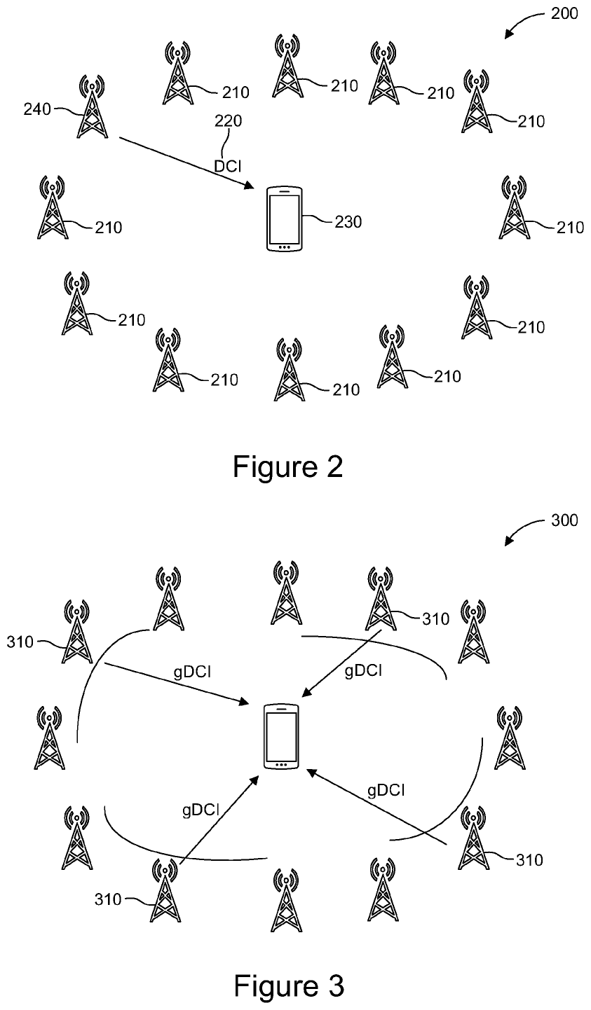

FIG. 5, shows an example, multi-DCI mechanism 500. A PDCCH carrying DCI is transmitted from each TRP 510. There are multiple PDCCHs carrying multiple DCIs 520 transmitted from multiple TRPs. Each DCI carries control information for each TRP including resource allocation information. Resource allocation information may be common for all TRPs. If resource allocation information is common for all TRPs, then the same resource allocation information is repeated in every DCI, which is not efficient for resource utilization.

A solution of hierarchical-DCI mechanism is proposed. In this solution a primary DCI and secondary DCI are introduced. A primary DCI or pDCI is used to carry TRP-common information. A secondary DCI or sDCI is used to carry TRP-specific information. pDCI is carried by primary PDCCH or pPDCCH. sDCI is carried in secondary PDCCH or sPDCCH. pDCI may be designed to have small payload and its performance could be very robust by design.

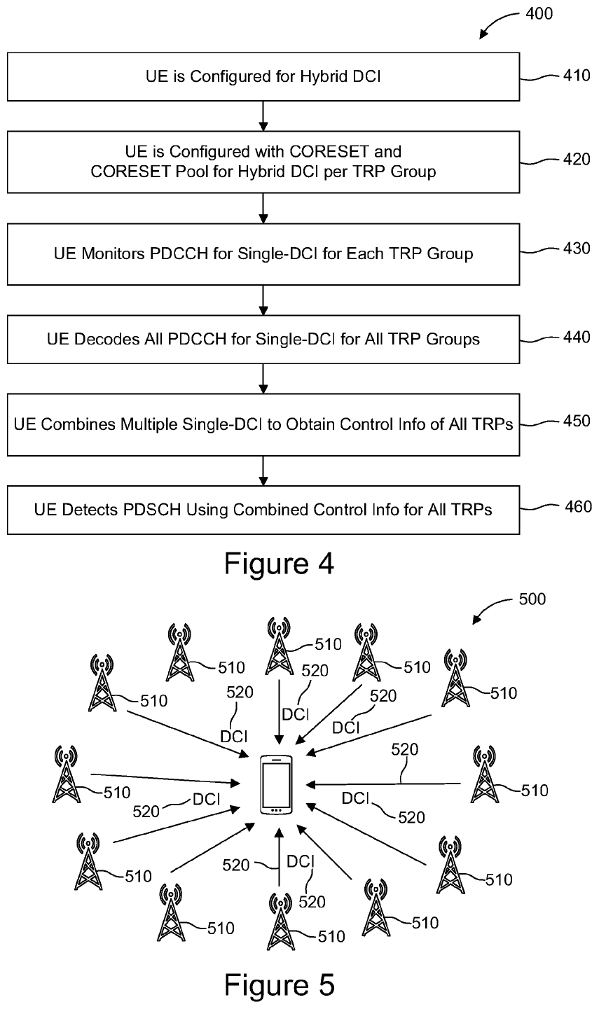

FIG. 6 depicts, an example method of hierarchical-DCI mechanism 600 for pDCI and sDCI. In multi-DCI scheme, freq-time resources may be fully overlapped from TRPs. It may also depend on WTRU capability. In this case, different PDSCHs/PUSCHs are transmitted from different TRPs. A pDCI 620 may be used to carry overlap resource information.

In the hierarchical-DCI mechanism of FIG. 6, a primary DCI 620 or pDCI is transmitted from one of TRPs 605. The pDCI 620 may carry critical control information and/or TRP-common control information for TRPs 605, 610. In addition, secondary DCI 630 or sDCI may carry TRP-specific control information. A pDCI 620 may carry information such as resource allocation or other information that are common across TRPs 610.

In extended hierarchical-DCI mechanism, TRPs may be grouped into several groups. A primary DCI or pDCI is transmitted from one of TRPs in each TRP group. pDCI may carry critical control information and/or TRP group-common control information for connected TRPs. In addition, secondary DCI or sDCI may carry TRP-specific control information. pDCI may carry information such as resource allocation or other information that is common across TRPs of each TRP group.

In a multi-DCI case, for fully overlapped resources among TRPs, pDCI may carry the resource allocation information. For coherent joint transmission in which freq-time resources may overlap, or in non-coherent joint transmission where freq-time resource may be forced to fully overlap, a pDCI may carry overlapped information. sDCI may carry any other remaining control information.

For partially overlapped resources among TRPs, pDCI may carry the partial overlap resource allocation information. In non-coherent joint transmission where freq-time resources may partially overlap, a pDCI may carry partially overlapped information. In this case, an sDCI may carry non-overlapped information among TRPs.

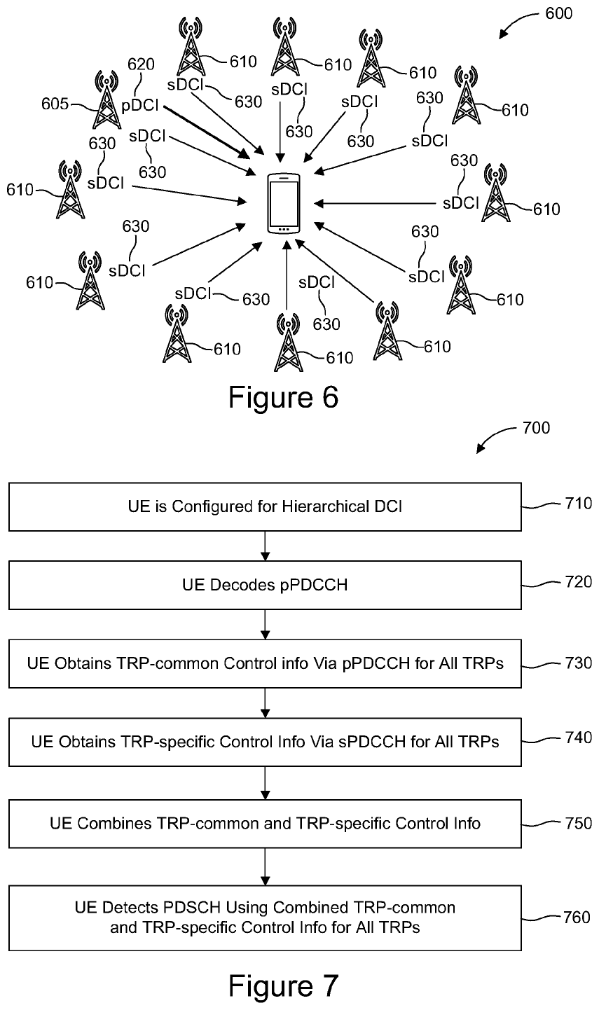

FIG. 7 depicts, an example method 700 of a hierarchical-PDCCH mechanism. A WTRU may be configured for hierarchical DCI operation mode, at 710. A WTRU may decode a primary PDCCH or pPDCCH, at 720. A WTRU could obtain a primary DCI or pDCI after successfully decoding primary PDCCH or pPDCCH, at 730. A WTRU could obtain the TRP-common control information in primary DCI or pDCI. A WTRU may also decode secondary PDCCH or sPDCCH, at 740. A WTRU could obtain a secondary DCI or sDCI after successfully decoding secondary PDCCH or sPDCCH. A WTRU could obtain the TRP-specific control information in secondary DCI or sDCI. A WTRU may combine TRP-common control information and TRP-specific control information for all TRPs, at 750. A WTRU may detect a PDSCH transmission using combined primary control information and secondary control information or TRP-common control information and TRP-specific control information for all TRPs, at 760.

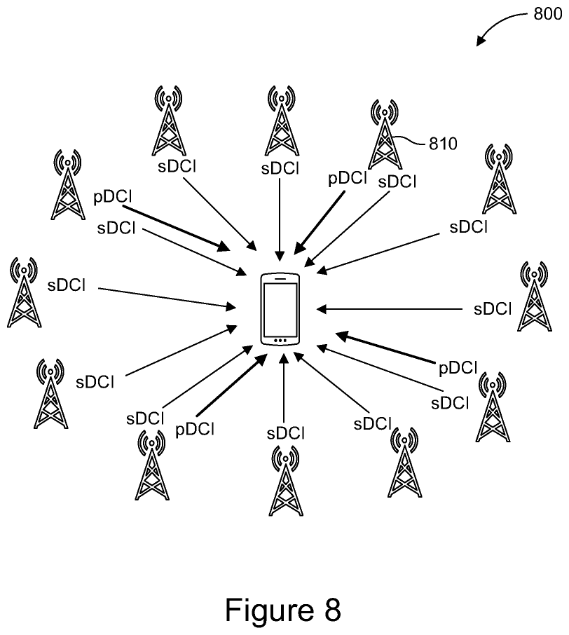

FIG. 8 shows an example method 800 of hierarchical-DCI mechanism for G-pDCI+sDCI. The method may also be referred to as hierarchical hybrid DCI (HH-DCI) scheme. Freq-time resources may be fully overlapped, partially overlapped or non-overlapped. Different PDSCH/PUSCH may be transmitted from TRPs. Non-overlapped may be mandatory. Depending on WTRU capabilities, fully overlapped or partially overlapped may also be supported. A WTRU may report its capability.

In hierarchical-DCI mechanism for multi-DCI, a primary group DCI or G-pDCI is transmitted from one of TRPs in a TRP group. G-pDCI may carry critical control information and/or group common control information for TRP group. In addition, secondary DCI or sDCI may carry TRP-specific control information for each TRP of TRP group. G-pDCI may carry information such as resource allocation or other info.

For non-coherent joint transmission, for overlapped resources among TRPs, G-pDCI may carry the overlapped resource allocation information for TRP group. Number of PDCCH may not be reduced, but the payload size may be reduced. Since in multi-DCI for M TRPs, M PDCCHs are needed. In hierarchical DCI, M+1 PDCCHs are needed. But in hierarchical DCI, sPDCCH has reduced payload size to carry TRP-specific info. Therefore, the overall overhead is reduced.

Both single-DCI and multi-DCI can support coherent joint transmission. For coherent joint transmission using single-DCI, freq-time resource fully overlapping, in such scheme, a single-DCI may carry overlapped information. For non-coherent joint transmission using multi-DCI, freq-time resource may be fully overlapped. In such scheme, pDCI may carry overlapped information. In this case, it may not be efficient to repeat resource allocation information in every DCI of multi-DCI. This causes the waste of resources and increases overhead. For a non-overlapped case, multi-DCI may be sufficient to use. For partial overlapped, a hybrid hierarchical DCI may be used. In this case, some partial common info is carried in pPDCCH and partial non-overlap info is carried in each of sPDCCH in multi-DCI.

For non-coherent or coherent joint transmission using multi-DCI, freq-time resource may fully overlap. In such a scheme, pPDCCH with pDCI in multi-DCI may carry overlapped information either fully overlapped or partially overlapped. sPDCCH with sDCI may carry any other non-overlapped information among TRPs.

For non-coherent joint transmission, partial overlap may be possible. In partial overlap, sometimes some TRPs may have overlap info but others may not. In this case, it may be beneficial to group TRPs based on overlapping condition. For non-overlap case, it may fall back to multi-DCI scheme in which each DCI carries its own resource info. For fully overlap case, it may fall back to single-DCI scheme. To form TRP groups, a WTRU may report measurements e.g., performs measurements on CSI-RS, and report the measurements to network, and network may decide the grouping of TRPs based on measurements. Alternatively a WTRU may also recommend the grouping of TRPs and send the recommendation to network. Yet another solution is that a WTRU may initiate the grouping and/or decide the grouping of TRPs, and then inform the decision to network. The measurements may include L1-RSRP, L1-RSRQ, CSI-RS resource index (CRI), L1-SINR, or the like, or combination of them.

As described previously, a Group pDCI, or G-pDCI may be used. TRPs may be in a group. One pDCI may be transmitted representing that TRP group. Such pDCI is called G-pDCI. In the example, four TRP groups are shown. One G-pDCI is transmitted per TRP group. In each TRP group, separate sDCI is transmitted for each TRP. TRP may be grouped based on certain criteria. For example, TRP grouping may be based on maximization of overlapped resources. If resources are not fully overlapped, they may belong to separate TRP groups. Other criteria may be applied for TRP grouping as well.

Several methods of downlink control information (DCI) and transmission configuration indication (TCI) are proposed for massively distributed MIMO and massive TRPs.

Hybrid-DCI scheme is proposed in which a TRP group PDCCH or gPDCCH is used to carry group DCI or gDCI for control information for a TRP group. Multiple gDCIs or multi-gDCI can be transmitted for multiple TRP groups. Each gDCI may contain control information for PDSCH reception or PUSCH transmission for TRP. Each gDCI may contain control information including resource allocation, TCI information, or the like. Resource allocation information may include frequency domain resource allocation (FDRA), time domain resource allocation (TDRA), or the like. To maintain the signaling overhead and scheduling flexibility, gPDCCH may be transmitted from a TRP group whose size may be maintained at reasonable and optimized size so that signaling overhead can be low and scheduling flexibility can be high.

Hierarchical-DCI scheme is proposed in which primary PDCCH or pPDCCH and secondary PDCCH or sPDCCH are transmitted. Primary PDCCH or pPDCCH may carry primary DCI or pDCI and secondary PDCCH may carry secondary DCI or sDCI. Primary DCI or pDCI may carry control information which may be common or critical for TRPs and secondary DCI or sDCI may carry control information which may be specific for TRPs. This may minimize the signaling overhead. Primary DCI or pDCI may carry common resource allocation information or overlap resource allocation information, and secondary DCI or sDCI may carry other control information including TCI information. An alternative may be that primary DCI or pDCI may carry control information which may be specific for TRPs and secondary DCI or sDCI may carry another set of control information which may also be specific for TRPs. Another alternative may be that primary DCI or pDCI may carry TRP-specific resource allocation information or non-overlap resource allocation information (e.g., TDRA, FDRA), and secondary DCI or sDCI may carry other control information including TCI information. Yet another alternative may be that primary DCI or pDCI may carry TRP-specific resource allocation information or non-overlap resource allocation information (e.g., TDRA, FDRA) as well as TCI information, and secondary DCI or sDCI may carry remaining control information or other control information.

A combination of hybrid-DCI and hierarchical-DCI schemes (hierarchical hybrid or HH-DCI) may also be possible. For example, a TRP group pDCI or G-pDCI may be transmitted per TRP group. Multiple G-pDCI may be transmitted for multiple TRP groups. Multiple sDCI may be transmitted per TRP groups.

Solutions for fast TCI indication and supporting large number of TRPs are proposed. Solutions may be to use secondary TCI field or fields for TCI indication of PDCCH to enable fast TCI indication. In addition, the secondary TCI field or fields can also be used to support more TCI states for massively distributed MIMO. When the second TCI field is present, then the very fast indication and switch can be achieved. The DCI may be used to indicate TCI states for control and data separately. WTRU may be configured for TCI states. WTRU may monitor PDCCH based on configuration. WTRU may detect a PDCCH transmission and decode DCI. If the second TCI field is configured, then WTRU may obtain TCI information from second TCI field in DCI. WTRU may use beam indicated in TCI of the second TCI field to decode next PDCCH. If the second TCI field is not configured, then WTRU may obtain TCI from MAC CE. WTRU may use beam indicated in MAC CE to decode next PDCCH. WTRU may obtain TCI from the first TCI field in DCI. WTRU may detect a current PDSCH using beam indicated in TCI of the first TCI field in DCI. To support large number of TRPs, WTRU may be configured for TCI states. WTRU may report TCI changes for TRPs. WTRU may receive re-activated TCI states via MAC CE based on reported TCI state changes. WTRU may receive TCI information e.g., in DCI where TCI indication may point to codepoints that are re-activated in MAC CE. WTRU may receive other control information for all TRPs. WTRU may detect and decode a PDSCH transmission using beams indicated in TCI states for all TRPs.

Adaptation mechanism for multiple DCI schemes is proposed in which a DCI scheme is selected based on certain criteria and conditions, e.g., transmission type, resource allocation type, resource overlap type, or the like. DCI/TCI scheme may be adaptive to optimize the spectrum efficiency, minimize the signaling overhead and enable the scheduling and operation flexibility of system. DCI/TCI scheme may be adapted between multiple DCI/TCI schemes such as single-DCI scheme, multi-DCI scheme, hybrid-DCI scheme and hierarchical DCI scheme. DCI/TCI adaptation may be determined based on certain criteria including but not limited to transmission type, resource allocation type and resource overlap type. The transmission type may be coherent or non-coherent joint transmission. Resource allocation type may be overlap or non-overlap resources. Resource overlap type may be full overlapping or partial overlapping.

DCI/TCI scheme may be adaptive based on number of DCIs (or PDCCHs) are transmitted, number of TRPs, or the like. WTRU may be configured with multiple DCI schemes. Full overlap resources may be allocated for PDSCH transmission (or PUSCH) for TRPs. If several DCIs are determined to be transmitted, the number of TRPs is further determined. If the number of TRPs is greater than a (pre-)configured threshold, then Hierarchical-DCI scheme could be activated and enabled (e.g., in MAC CE). WTRU may decode pPDCCH from one TRP. WTRU may obtain common resource allocations for TRPs. WTRU may decode sPDCCH from multiple TRPs and obtain different TCIs via sDCI for TRPs. WTRU may detect a PDSCH transmission using common resource allocations via pDCI and different beams indicated by TCIs via sDCI for TRPs. If the number of TRPs is not greater than or smaller then a (pre-)configured threshold, then Multi-DCI scheme could be activated and enabled (e.g., in MAC CE). WTRU may decode multiple PDCCHs from multiple TRPs. WTRU may obtain different resource allocations and TCIs for TRPs. WTRU may detect a PDSCH transmission using separate resource allocations and different beams indicated by TCIs for TRPs. If several DCls are not determined to be transmitted, and only single DCI is determined to be transmitted, then Single-DCI scheme could be activated and enabled (e.g., in MAC CE). WTRU may decode a single PDCCH transmission from single TRP.

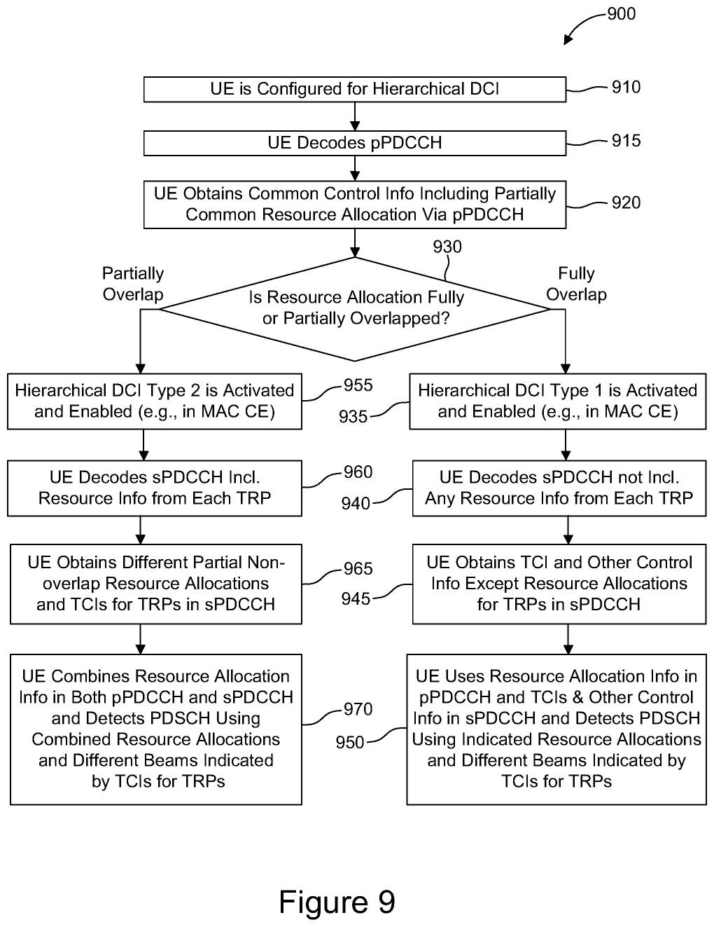

FIG. 9 shows an example method 900 of hierarchical-PDCCH mechanism to support partially overlapped resource allocation. A WTRU may be configured for operating in hierarchical DCI mode, at 910. A WTRU may decode primary PDCCH or pPDCCH, at 915. A WTRU may obtain common control information or partially common control information via pPDCCH, at 920.

A WTRU may be scheduled for data reception or transmission via resource allocation, e.g. in a DCI in a pPDCCH transmission. Depending on resource allocation conditions, whether it is fully overlap or partial overlap, different DCI type may be used, 930. If it is fully overlap in resource allocation, then hierarchical DCI type 1 may be activated and enabled, at 935. For example, hierarchical DCI type may be activated and enabled via MAC CE. A WTRU may decode a secondary PDCCH transmission, or a sPDCCH transmission which may not include resource allocation information for TRPs, at 940. A WTRU may obtain TCI information and other control information except resource allocation information in a secondary PDCCH or sPDCCH, at 945. A WTRU may use resource allocation information in pPDCCH and TCIs and other control information in sPDCCH and detect a PDSCH transmission using indicated resource allocations and different beams indicated by TCIs for TRPs, at 950.

If it is partially overlap in resource allocation, then hierarchical DCI type 2 may be activated and enabled, at 955. For example, hierarchical DCI type may be activated and enabled via MAC CE. A WTRU may decode sPDCCH including resource information from each TRP, at 960. A WTRU may obtain different partial non-overlap resource allocation information and TCIs for TRPs in sPDCCH, at 965. WTRU may combine resource allocation information in both pPDCCH and sPDCCH and detect a PDSCH transmission using combined resource allocations and different beams indicated by TCIs for TRPs, at 970.

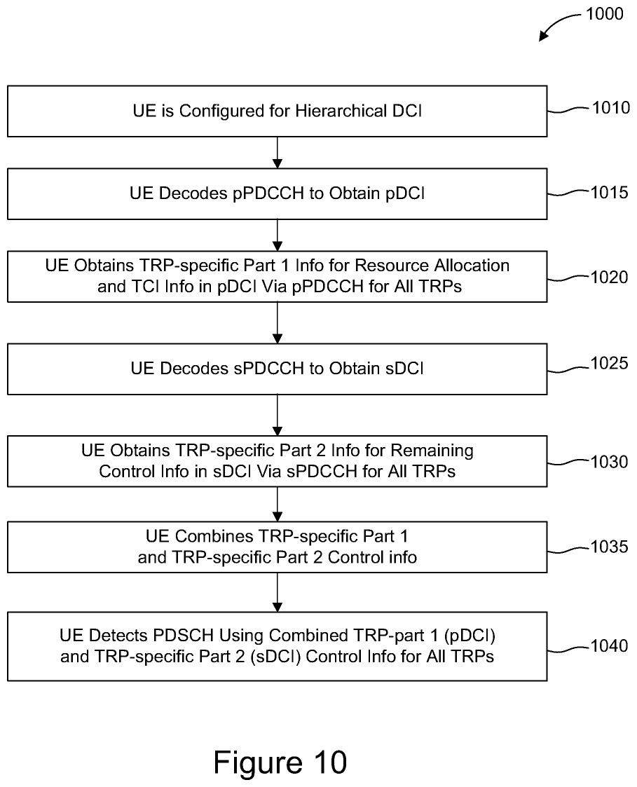

FIG. 10 shows an example method 1000 of resource allocation using a hierarchical-PDCCH mechanism (TCI information in pDCI). A WTRU may be configured for hierarchical DCI scheme, at 1010. A WTRU may decode pPDCCH to obtain pDCI, at 1015. A WTRU may obtain TRP-specific part 1 information for resource allocation and TCI information in pDCI via pPDCCH for all TRPs, at 1020. A WTRU may decode sPDCCH to obtain sDCI, at 1025. A WTRU could obtain TRP-specific part 2 information for remaining control information in sDCI via sPDCCH for all TRPs, at 1030. A WTRU could combine TRP-specific part 1 control information and TRP-specific part 2 control information, at 1035. WTRU may detect a PDSCH transmission using the combined TRP-specific part 1 (pDCI) and TRP-specific part 2 (sDCI) control information for all TRPs, at 1040.

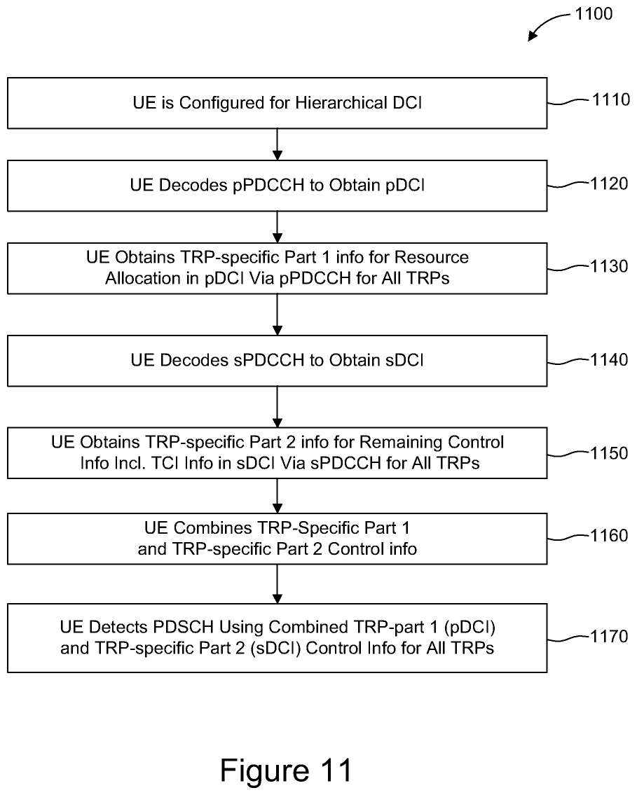

FIG. 11 shows an example method 1100 resource allocation using a hierarchical-PDCCH mechanism (TCI information in sDCI). A WTRU may be configured for hierarchical DCI scheme, 1110. A WTRU may decode a pPDCCH to obtain pDCI, at 1120. A WTRU could obtain TRP-specific part 1 control information for resource allocation in pDCI via pPDCCH for all TRPs, at 1130. A WTRU could decode sPDCCH to obtain sDCI, at 1140. A WTRU may obtain TRP-specific part 2 control information for remaining control information including TCI information in sDCI via sPDCCH for all TRPs, at 1150. A WTRU could combine TRP-specific part 1 and TRP-specific part 2 control information, at 1160. A WTRU may detect a PDSCH transmission using combined TRP part 1 (pDCI) and TRP-specific part 2 (sDCI) control information for all TRPs, at 1170.

Methods of Enhanced Transmission Configuration Indication TCI Mechanism for Massively Distributed MIMO are discussed herein. The number of TCIs could be very large (e.g. greater than 128) for massive MIMO. In addition, number of TRPs could also be very large (e.g. greater than 4) for massively distributed MIMO. Combination of both could increase TCI states and codepoints significantly. These scenarios could increase overhead in DCI and/or MAC CE.

In addition, whether to use a DCI or MAC CE may depend on control or data. For a fast indication, MAC CE should be used. For a very fast indication, a DCI should be used. Unified TCI or non-unified TCI may be used. Unified TCI refers to a single TCI applied for both control and a data, or for DL and UL. Non-unified TCI uses separate TCIs for control and data, and for DL and UL. In non-unified TCI, there is no mechanism to switch between DCI-based or MAC CE-based. In unified TCI, there is a mechanism to switch between DCI-based or MAC CE-based. This can be done by MAC CE. If a MAC CE activates only one TCI state, then a MAC CE is used to indicate TCI state for control and data. If a MAC CE activates more than one TCI state, then a DCI is used to indicate TCI state for control and data.

A unified TCI may be reused to achieve fast and very fast indications and to switch between them. However, the flexibility may be lost since unified TCI is designed to simplify the TCI method and reduce overhead at the cost of flexibility. Control and data cannot be indicated separately if different beams are used for them. Solutions are required to achieve fast and very fast indications and to switch for non-unified TCI.

Solutions may be to use secondary TCI field for TCI indication of PDCCH to enable fast TCI indication. In addition, the secondary TCI field may also be used to support more TCI states for massively distributed MIMO.

One solution may be to use a DCI to indicate a TCI state for control. For mini-slot, first DCI can schedule the first PDSCH and indicate a TCI state for the second DCI or subsequent DCIs in the same slot. Similarly, the second DCI can schedule the second PDSCH and indicate a TCI state for the third DCI or subsequent DCIs in the same slot.

For a regular slot, the first DCI may schedule the first PDSCH transmission and indicate TCI state for the second DCI or subsequent DCIs in a next symbol, slot, or subsequent symbols or slots. Similarly, the second DCI may schedule the second PDSCH and indicate a TCI state for the third DCI or subsequent DCIs in next symbol, slot, or subsequent symbols and slots.

To indicate TCI states separately for control and data, two TCI fields in a DCI may be introduced. The first TCI field is mandatory. The second TCI field is optional. The second TCI field can be configured by RRC. If configured, then the second TCI field is present, otherwise the second TCI field is not present.

When the second TCI field is present, then the very fast indication and switch may be achieved. The DCI may be used to indicate TCI states for control and data separately.

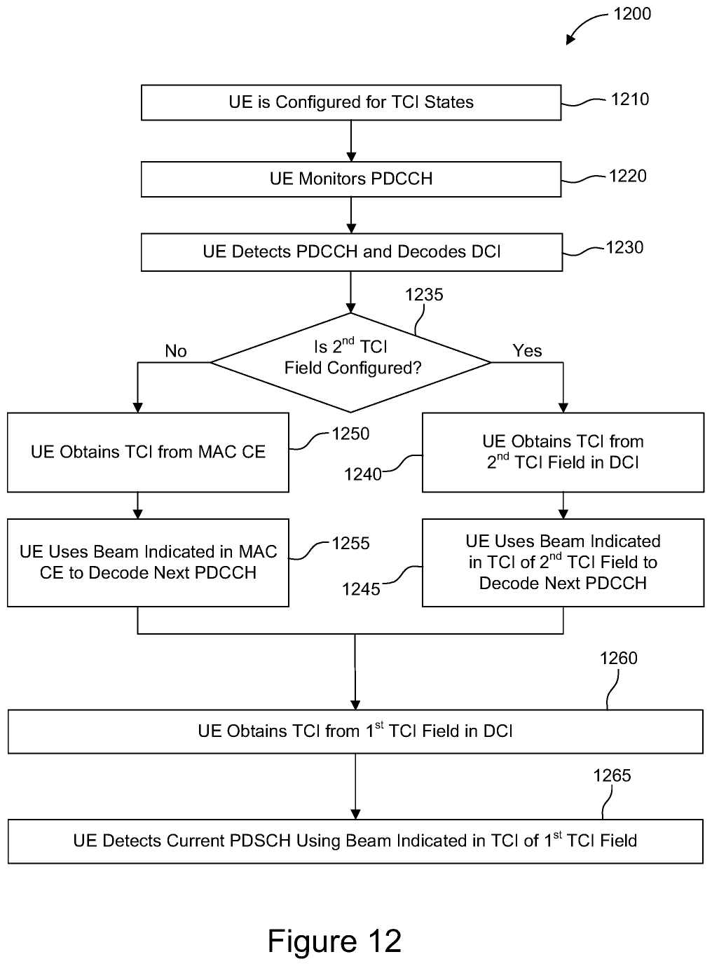

FIG. 12 shows an example method 1200 resource allocation utilizing a fast TCI indication. A WTRU may be configured for TCI states, at 1210. A WTRU may monitor PDCCH transmissions based on configuration, at 1220. A WTRU may detect a PDCCH transmission and decode a DCI, at 1230. If the second TCI field is configured, then a WTRU may obtain TCI information from second TCI field in DCI. at 1240. The WTRU may use a beam indicated in TCI of the second TCI field to decode next PDCCH, at 1245. If the second TCI field is not configured, then a WTRU may obtain TCI from MAC CE, at 1250. A WTRU may use a beam indicated in MAC CE to decode next PDCCH transmission, at 1255. A WTRU may obtain TCI from the first TCI field in DCI, at 1260. A WTRU may detect a current PDSCH transmission using a beam indicated in TCI of the first TCI field in the DCI, at 1265

Each TCI codepoint can indicate multiple TCI states. The first and second TCI fields can indicate a codepoint that contains multiple TCI states. For massively distributed MIMO, the first TCI field can indicate a codepoint that contains 16, 32, 64 or more TCI states. Similarly, the second TCI field can indicate a codepoint that contains 16, 32, 64 or more TCI states. TCI field may be one of the control fields in DCI. TCI field may contain bits which could indicate one of the TCI codepoints. Each TCI codepoint may contain or point to one or multiple TCI states.

The first TCI field and the second TCI field may be configured with different bit-width depending on different scenarios and use cases. For example, if wider beam is used for control and narrower beam is used for data, then the second TCI field may be configured with smaller bit-width than the first TCI field.

One solution (scheme 1), may be to use another DCI field. Another solution (scheme 2) may be to activate a set of TCI pairs in MAC CE. Yet another solution (scheme 3) may be to activate a subset of TCI pairs in MAC CE. To adapt TCI based on WTRU mobility and to support high WTRU mobility, a fast TCI activation/deactivation is required. WTRU may report its mobility (e.g., speed, direction, positioning info, etc). TCI scheme may be switched between scheme 1 and 3. If mobility is higher than a threshold, the fast TCI adaptation is required, and scheme 1 (or scheme 2) with DCI is used. If mobility is not higher than a threshold, the slow TCI adaptation is required, and scheme 3 with DCI is used. Slow TCI adaptation scheme requires 2-stage processing involving MAC CE and DCI to work together. While Fast TCI adaptation scheme does not require 2-stage processing and not involving MAC CE and DCI to work together. It only requires DCI to change the TCI state which is much faster than joint MAC CE and DCI approach. It should be noted that the mobility threshold may be a (pre-)configured speed threshold, (pre-)configured direction range, or a (pre-)configured distance from a reference point.

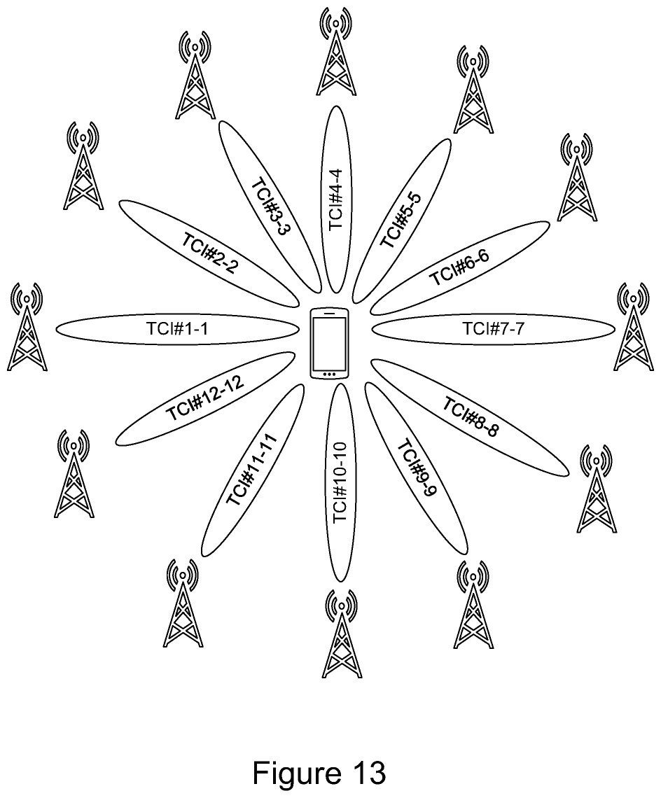

FIG. 13 shows than example of a beam status before TCI pairing is applied.

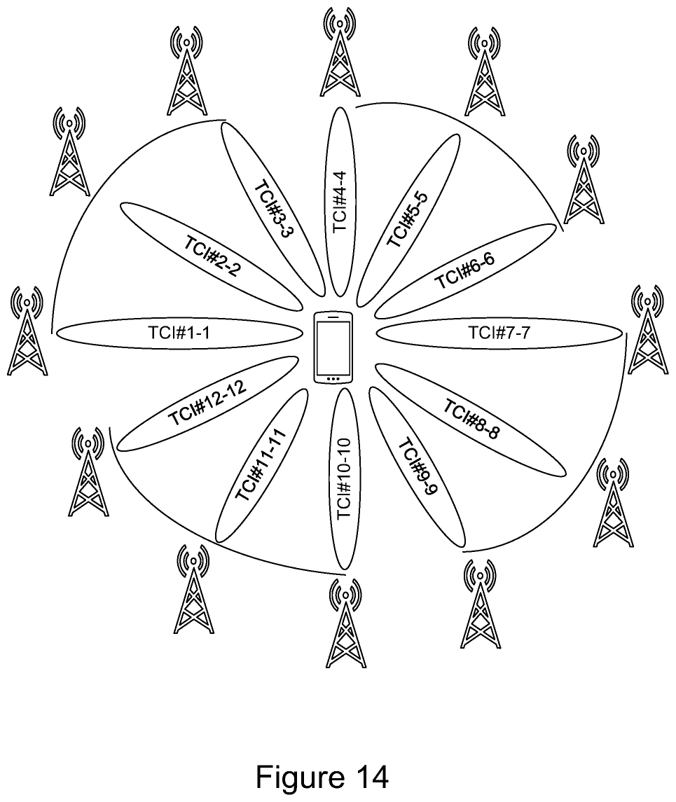

Another solution, shown in FIG. 14, may be to group TRPs in the nearby, adjacent, or similar direction so that TCI changes may not be dramatic. For 12 TRPs and M1=4 groups (M2=3 TRPs for each group), M=M1×M2. 8\hat{ }M1=8\hat{ }4 combinations (associations) may be needed. This may reduce overhead by a factor of 3.

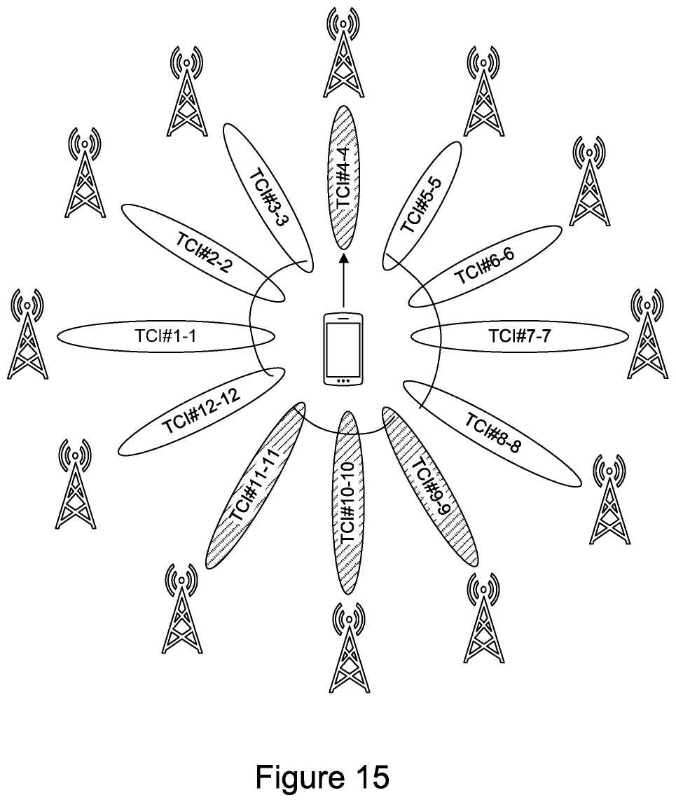

In another solution, shown in FIG. 15, TRPs may be grouped based on WTRU mobility so that one group contains TCI changes that may not be major and another group contains TCI changes may be major. Major TCI changes includes situations in which a larger number of beams need to be changed or updated. Minor TCI changes includes situation in which only a smaller number of beams to need to be changed or updated. In FIG. 15 a WTRU may report TCI change rate, beam switching rate, CSI-RS measurement, or the like for each TRP or TRP groups. Based on the report, TRPs may be regrouped to form new groups such that in the new TRP groups, TRP with major TCI changes may belong to the same group while TRP with minor or no TCI changes may belong to a different group. For 12 TRPs and M1=2 groups (M2=6 TRPs for each group), M=M1×M2. 8\hat{ }M1=8\hat{ }2 combinations (associations) may be needed. This reduces overhead by six times.

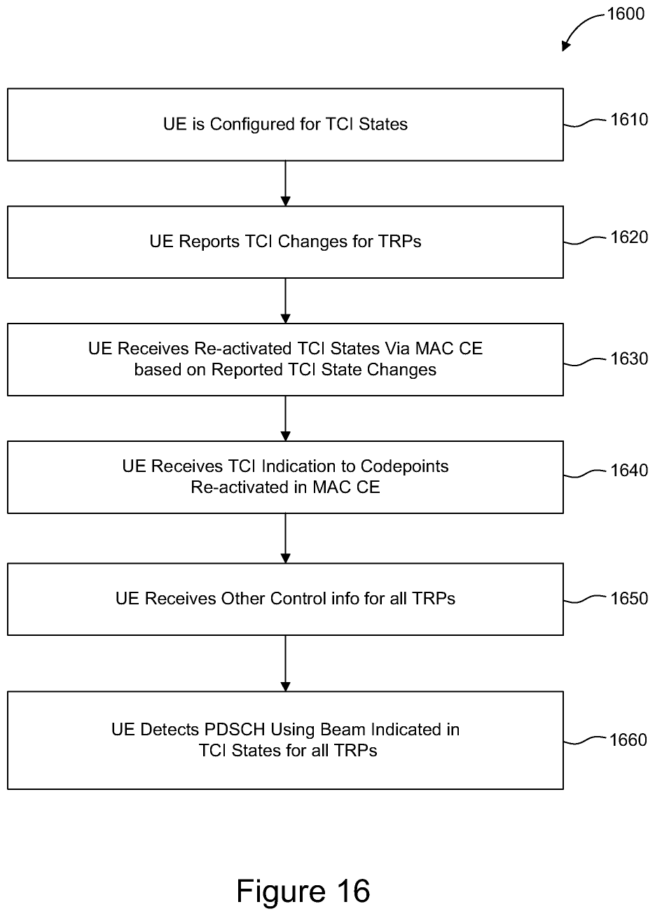

FIG. 16, shows an example method 1600 of TCI for massively distributed MIMO. A WTRU may be configured for TCI states, at 1610. A WTRU may report TCI changes for TRPs, at 1620. A WTRU may receive re-activated TCI states via MAC CE based on reported TCI state changes, at 1630. A WTRU may receive a TCI indication to codepoints that are re-activated in a MAC CE, at 16340. A WTRU may receive other control information for all TRPs, at 1650. A WTRU may detect and decode PDSCH transmissions using beams indicated in TCI states for all TRPs, at 1660.

For number of TRPs>>4, additional multiple TCI fields may be needed. To have a unified DCI design with fast TCI indication using DCI or supporting more TCI states using DCI, two TCI fields in a DCI may be used and other TCI fields may be converted into TCI states in codepoints in a MAC CE. In this way either mode can be configured. For example, the fast TCI indication mode or secondary TCI states mode for massively distributed MIMO may be configured. If both modes are configured, a one-bit flag may be used to indicate which mode a WTRU should operate using.

Methods of Dynamic Switching for Single-DCI and Multi-DCI for Massively Distributed MIMO are described herein. Single-DCI and multi-DCI are supported for multi-TRP scenarios. Whether to use single-DCI or multi-DCI may be configurable by RRC signaling. Due to rapid change of channels and enhance flexibility of system operation, a fast switch between DCI mechanisms is desirable.

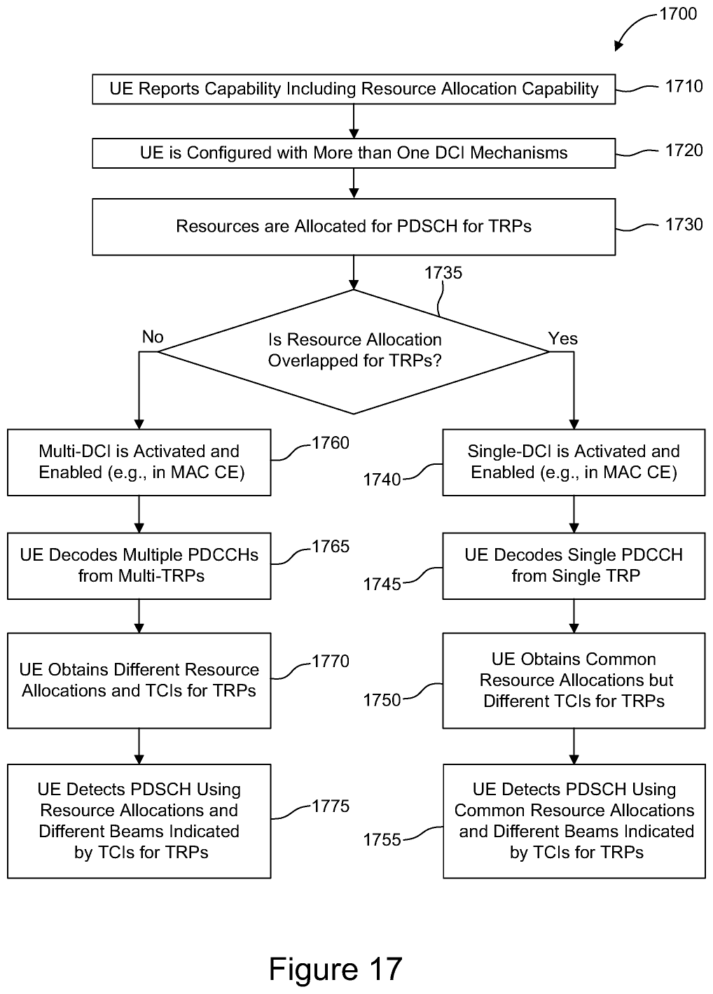

FIG. 17 shows an example method 1700 of DCI mechanism switching, A WTRU may report capability including resource allocation handling capability, at 1710. A WTRU may be configured with more than one DCI mechanisms including single-DCI and multi-DCI mechanisms, at 1720. Resources may be allocated for PDSCH and/or PUSCH for communications with TRPs, at 1730.

If resource allocation is overlapped in frequency and time for TRPs, then single-DCI may be activated and enabled (e.g., in MAC CE), at 1740. A WTRU may decode a single PDCCH from a single TRP, at 1745. A WTRU may obtain common resource allocations using different TCIs for TRPs, at 1750. A WTRU may detect PDSCH transmissions using common resource allocations and different beams indicated by TCIs for TRPs, at 1755.

If resource allocation is not overlapped for TRPs, then multi-DCI may be activated and enabled (e.g., in MAC CE), at 1760 A WTRU may decode multiple PDCCHs from multi-TRPs, at 1765. A WTRU may obtain different resource allocations and TCIs for TRPs, at 1770. A WTRU may detect PDSCH transmissions using separate resource allocations and different beams indicated by TCIs for TRPs, at 1775.

Both single DCI and multi-DCI schemes may be configured simultaneously, and overlapped resource allocations may be dynamically determined and assigned. Depending on a resource allocation whether resource allocations overlap or not, one of the DCI schemes may be activated or enabled. Alternatively, the gNB may determine that an overlapped resource allocation will be used and then configured, activate or enable one of the DCI schemes, e.g., the single DCI scheme or multi-DCI scheme.

Methods of Adaptation for DCI/TCI Mechanism for Massively Distributed MIMO are described herein. DCI/TCI scheme may be adaptive to optimize the spectrum efficiency, minimize the signaling overhead and enable the scheduling and operation flexibility of system. DCI/TCI scheme may be adapted between multiple DCI/TCI schemes such as single-DCI scheme, multi-DCI scheme, hybrid-DCI scheme, and hierarchical DCI scheme. DCI/TCI adaptation may be determined based on certain criteria including but not limited to transmission type, resource allocation type and resource overlap type. The transmission type may be coherent or non-coherent joint transmission. Resource allocation type may be overlap or non-overlap resources. Resource overlap type may be full overlapping or partial overlapping.

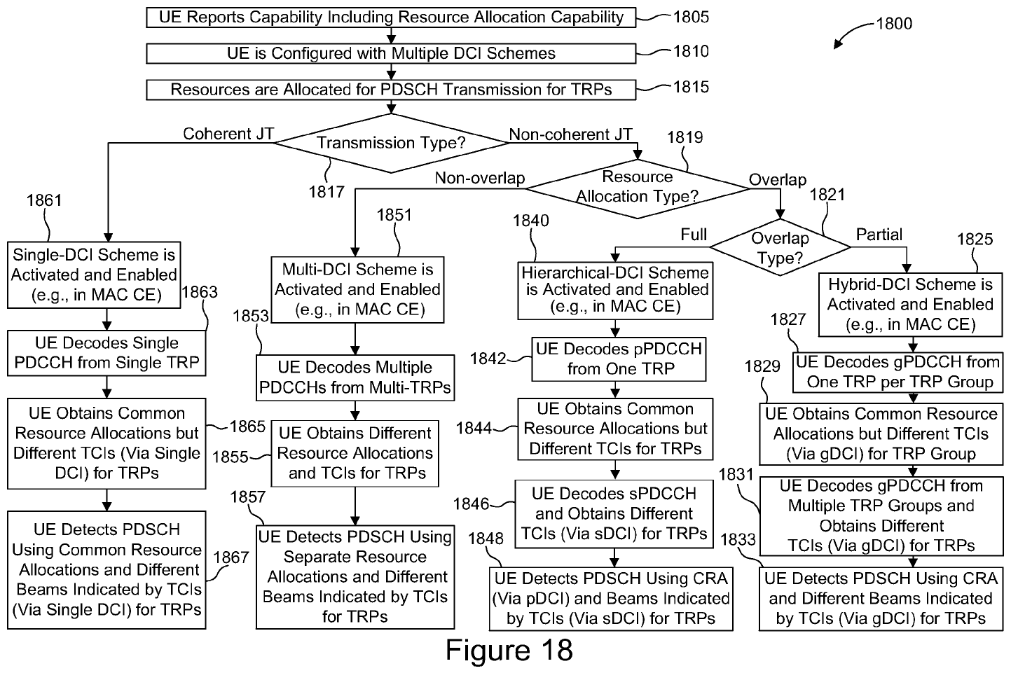

FIG. 18 shows an example method 1800 of an adaptation mechanism for DCI/TCI scheme. A WTRU may report capability including resource allocation capability, at 1805. A WTRU may be configured with multiple DCI schemes, at 1810. Resources are allocated for PDSCH transmission for TRPs, at 1815.

If transmission type is determined, at 1817, to be non-coherent joint transmission, the resource allocation type is further determined, at 1819. If resource allocation type is determined to be overlap type, then resource overlap type is further determined, at 1821.

If resource overlap type is partial overlap, then Hybrid-DCI scheme is activated and enabled (e.g., in MAC CE), at 1825. WTRU may decode a gPDCCH transmission from one TRP per TRP group, at 1827. A WTRU may obtain common resource allocations but different TCIs (via gDCI) for TRP group, at 1829. A WTRU may decode gPDCCH from multiple TRP groups and obtain different TCIs (via gDCI) for TRPs, at 1831. A WTRU may detect PDSCH transmissions using common resource allocation (CRA) and different beams indicated by TCIs (via gDCI) for TRPs, at 1833.

If resource overlap type is determined to be full overlap, at 1821, then Hierarchical-DCI scheme is activated and enabled (e.g., in MAC CE), at 1840. A WTRU may decode a pPDCCH transmission from one TRP, at 1842. A WTRU may obtain common resource allocations (CRA) but different TCIs for TRPs, at 1844. A WTRU may decode sPDCCH and obtain different TCIs (via sDCI) for TRPs, at 1846. A WTRU may detect PDSCH transmissions using CRA (via pDCI) and beams indicated by TCIs (via sDCI) for TRPs, at 1848.

If transmission type is determined to be non-coherent joint transmission (NCJT), at 1817, with resource allocation type being determined to be non-overlap type, at 1819, then Multi-DCI scheme is activated and enabled (e.g., in MAC CE), at 1851. A WTRU may decode multiple PDCCHs transmissions from multi-TRPs, at 1853. A WTRU may obtain different resource allocations and TCIs for TRPs, at 1855. A WTRU may detect PDSCH transmissions using separate resource allocations and different beams indicated by TCIs for TRPs, at 1857.

If transmission type is determined to be coherent joint transmission (CJT), at 1817, then a Single-DCI scheme is activated and enabled (e.g., in MAC CE), at 1861. A WTRU may decode single PDCCH from single TRP, at 1863. A WTRU may obtain common resource allocations but different TCIs (via single DCI) for TRPs, at 1865. A WTRU may detect PDSCH transmissions using common resource allocations and different beams indicated by TCIs (via single DCI) for TRPs, at 1867.

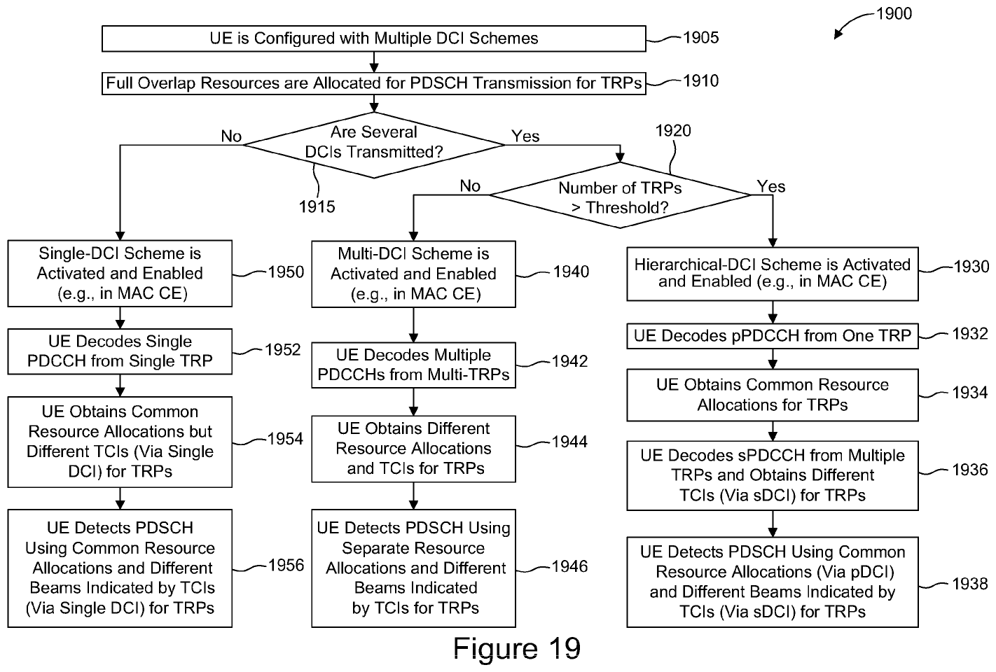

FIG. 19 shows an example method 1900 of adaptation for a DCI/TCI mechanism. DCI/TCI scheme may be adaptive based on a number of DCIs (or PDCCHs) that are transmitted, number of TRPs, or the like. A WTRU may be configured with multiple DCI schemes, at 1905. Full overlap resources may be allocated for PDSCH transmission (or PUSCH) for TRPs, at 1910. If several DCls are determined to be transmitted, at 1915, the number of TRPs is further determined and compared to a threshold, at 1920. If the number of TRPs is greater than a (pre-)configured threshold, then Hierarchical-DCI scheme could be activated and enabled (e.g., in MAC CE), at 1930. WTRU may decode pPDCCH from one TRP, at 1932. A WTRU may obtain common resource allocations for TRPs, at 1934. A WTRU may decode sPDCCH transmissions from multiple TRPs and obtain different TCIs via sDCI for TRPs, at 1936. A WTRU may detect PDSCH transmissions using common resource allocations via pDCI and different beams indicated by TCIs via sDCI for TRPs, at 1938.

If the number of TRPs is not greater than or smaller then a (pre-)configured threshold, at 1920, then Multi-DCI scheme could be activated and enabled (e.g., in MAC CE), at 1940. A WTRU may decode multiple PDCCHs from multiple TRPs, at 1942. A WTRU may obtain different resource allocations and TCIs for TRPs, at 1944. A WTRU may detect a PDSCH transmission using separate resource allocations and different beams indicated by TCIs for TRPs, at 1946.

If several DCIs are not determined to be transmitted, at 1915, and only single DCI is determined to be transmitted, then Single-DCI scheme could be activated and enabled (e.g., in MAC CE), at 1950. WTRU may decode single PDCCH from single TRP, at 1952. A WTRU may obtain common resource allocations but different TCIs via single DCI for TRPs, at 1954. A WTRU may detect a PDSCH transmission using common resource allocations and different beams indicated by TCIs via single DCI for TRPs, at 1956.

In one embodiment, a WTRU may perform a Hybrid-DCI (Hb-DCI) operation and procedure for massively distributed MIMO. In this case a WTRU may be configured for hybrid DCI mechanism. A WTRU may be configured with a CORESET and/or a CORESET pool for hybrid DCI. Such configuration may be for TRP group.

A WTRU may be configured to perform at least one of the following: monitor group PDCCH or gPDCCH for group DCI or gDCI in a search space of CORESET associated with each TRP group; decode group PDCCH or gPDCCH for each TRP group and for all TRP groups accordingly; obtain TRP group common resource allocations but different TCIs (via gDCI) for TRP group; decode gPDCCH from multiple TRP groups and obtain TCI information (via gDCI) for TRPs; combine all gDCIs that are decoded in gPDCCHs to obtain control information for all TRPs; detect a PDSCH transmission using group common resource allocation (GCRA) and different beams indicated by TCI states (via gDCI) for TRPs; decode and demodulate PDSCH transmissions from TRPs using combined control information and TCI information obtained for all TRPs, or transmit PUSCH tranmissions to TRPs using combined control information and TCI information obtained for all TRPs.

In another embodiment, a WTRU may be configured to performs Hierarchical-DCI (Hi-DCI) operation and procedure for massively distributed MIMO.

A WTRU may be configured to do at least one of the following: decode primary PDCCH or pPDCCH transmissions from one of plurality of TRPs; obtain control information for common resource allocations (CRA) information for TRPs; if Hierarchical Hybrid DCI (HH-DCI) scheme is enabled, obtain control information for group common resource allocations (GCRA) information for TRPs; obtain different TCI states in either gDCl/g-gDCI or sDCI information for TRPs; decode secondary PDCCH or sPDCCH; obtain different TCI state information (via sDCI) for TRPs if TCI information is not carried in pDCI or G-pDCI; detect a PDSCH transmissions or transmit a PUSCH transmission using CRA indicated in primary downlink control information (pDCI) or GCRA indicated in group pDCI (G-pDCI) and beams indicated by TCI state information in pDCI, G-pDCI or sDCI for TRPs.

In another exemplary embodiment, a WTRU may perform an adaptation mechanism for multiple DCI/TCI schemes operation and procedures for massively distributed MIMO. A DCI/TCI scheme may be adaptive to optimize the spectrum efficiency, minimize the signaling overhead and enable the scheduling and operation flexibility of a system. A DCI/TCI scheme may be adapted between multiple DCI/TCI schemes such as a single-DCI scheme, multi-DCI scheme, hybrid-DCI scheme, and hierarchical DCI scheme. DCI/TCI adaptation may be determined based on certain criteria including but not limited to a transmission type, resource allocation type and resource overlap type. The transmission type may be coherent or non-coherent joint transmission. Resource allocation type may be overlapped or non-overlapped resources. Resource overlap type may be full overlapping or partial overlapping.

A WTRU may be configured with multiple DCI schemes. Resources are allocated for PDSCH transmissions for TRPs. More specifically, a WTRU may be configured to do at least one of the following: report capability information including resource allocation capability information; if transmission type is determined to be non-coherent joint transmission, the resource allocation type is further determined; if the resource allocation type is determined to be overlap type, then resource overlap type is further determined; if the determined resource overlap type is partial overlap, then a Hybrid-DCI scheme is activated and enabled (e.g., in MAC CE); decode gPDCCH from one TRP per TRP group; obtain common resource allocations but different TCIs (via gDCI) for TRP group; decode gPDCCH from multiple TRP groups and obtain different TCIs (in gDCI) for TRPs; detect PDSCH using common resource allocation (CRA) and different beams indicated by TCIs (via gDCI) for TRPs; if resource overlap type is determined to be full overlap, then Hierarchical-DCI scheme is activated and enabled (e.g., in MAC CE); decode pPDCCH from one TRP; obtain common resource allocations (CRA) but different TCIs for TRPs; decode sPDCCH and obtain different TCIs (via sDCI) for TRPs; detect PDSCH or transmit PUSCH using CRA (via pDCI) and beams indicated by TCIs (via sDCI) for TRPs; if transmission type is determined to be non-coherent joint transmission (NCJT) with resource allocation type being determined to be non-overlap type, then Multi-DCI scheme is activated and enabled (e.g., in MAC CE); decode multiple PDCCH transmissions from multi-TRPs; obtain different resource allocations and TCIs for TRPs; detect a PDSCH transmission or transmit PUSCH using separate resource allocations and different beams indicated by TCIs for TRPs; if transmission type is determined to be coherent joint transmission (CJT), then Single-DCI scheme is activated and enabled (e.g., in MAC CE); decode single PDCCH transmission from single TRP; obtain common resource allocations but different TCIs (via single DCI) for TRPs; and/or detect PDSCH using common resource allocations and different beams indicated by TCIs (via single DCI) for TRPs.

In another exemplary embodiment, a WTRU may perform an adaptation mechanism for multiple DCI schemes operation and procedure for massively distributed MIMO. DCI/TCI scheme may be adaptive based on number of DCIs (or PDCCHs) to be transmitted, number of TRPs, or the like. A WTRU may be configured with multiple DCI schemes. Full overlap resources may be allocated for a PDSCH transmission (or PUSCH) for TRPs. A WTRU may also configured to perform the at least any one of the following: if several DCIs are determined to be transmitted, the number of TRPs is further determined; if the determined number of TRPs is greater than a (pre-)configured threshold, then a Hierarchical-DCI scheme is activated and enabled (e.g., in MAC CE); decode pPDCCH transmission from one TRP; obtain common resource allocations in pDCI for TRPs; decode sPDCCH transmissions from multiple TRPs and obtain different TCIs in sDCI for TRPs; detect PDSCH or transmit PUSCH using common resource allocations via pDCI and different beams indicated by TCIs in sDCI for TRPs; if the determined number of TRPs is not greater than or smaller then a (pre-)configured threshold, then Multi-DCI scheme is activated and enabled (e.g., in MAC CE); decode multiple PDCCHs from multiple TRPs; obtain different resource allocations and TCIs in multiple DCIs carried in multiple PDCCHs for TRPs; detect a PDSCH transmission or transmit a PUSCH transmission using separate resource allocations and different beams indicated by TCIs in multiple DCIs for TRPs; if several DCIs are not determined to be transmitted, and only single DCI is determined to be transmitted, then Single-DCI scheme is activated and enabled (e.g., in MAC CE); decode a single PDCCH transmission from a single TRP; obtain different resource allocations and TCIs in single DCI carried in a single PDCCH transmission for TRPs; and/or detect a PDSCH transmission. or transmit a PUSCH transmission using separate resource allocations and different beams indicated by TCIs in single DCI for TRPs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, performed by a WTRU, of switching between a multiple DCI/TCI scheme operation, the method comprising:
sending the WTRU capabilities including resource allocation handling capabilities;
receiving first configuration information for a first DCI/TCI scheme;
using the first DCI/TCI scheme to receive an allocation of resources for receiving physical downlink shared channel (PDSCH) transmissions from multiple transmission reception points (TRPs);
receiving configuration information for a second DCI/TCI scheme; and
switching from the first DCI/TCI scheme to the second DCI/TCI scheme to receive an allocation of resources for receiving PDSCH transmissions from the multiple TRPs, wherein the first DCI/TCI scheme is a hierarchical-DCI/TCI scheme, and the second DCI/TCI scheme is a hybrid-DCI/TCI scheme.

2. (canceled)

3. The method of claim 1 wherein the hierarchical-DCI/TCI scheme includes the WTRU: decoding a primary PDCCH (pPDCCH) transmission from one TRP of the multiple TRPs, obtaining common resource allocations for TRPs of the multiple TRPs, decoding secondary PDCCH (sPDCCH) transmissions and obtaining different TCIs for different TRPs, and detecting a PDSCH transmission using a common resource allocation (CRA) and beams indicated by the different TCIs for different TRPs of the multiple TRPs.

4. The method of claim 1, wherein the hybrid-DCI/TCI scheme includes the WTRU: decoding a group PDCCH (gPDCCH) transmission from one TRP of the multiple TRPs, obtaining common resource allocations (CRA) and different TCIs for a TRP group, decoding a gPDCCH transmission from multiple TRP groups and obtaining different TCIs for TRPs, and detecting a PDSCH transmission using CRA per group of TRPs and different beams indicated by the different TCIs for the group of TRPs.

5. The method of claim 1, wherein the switching from the first DCI/TCI scheme to the second DCI/TCI scheme is based on a MAC CE.

6. The method of claim 1 further comprising: transmitting a PUSCH transmission to TRPs using combined control information and TCI information obtained for all TRPs using the second DCI/TCI.

7. The method of claim 1, wherein the first DCI/TCI scheme is a multi-DCI/TCI scheme.

8. The method of claim 1, wherein the first DCI/TCI scheme is a single-DCI scheme.

9. A wireless transmit/receive unit (WTRU) operate using multiple DCI/TCI schemes, the WTRU comprising:
a transmitter configured to transmit WTRU capabilities including resource allocation handling capabilities;
a receiver configured to receive a first configuration information for a first DCI/TCI scheme;
a processor coupled to the receiver, configured to use the first DCI/TCI scheme to receive an allocation of resources for receiving physical downlink shared channel (PDSCH) transmissions from multiple transmission reception points (TRPs);
the receiver further configured to receive configuration information for a second DCI/TCI scheme; and
the processor and receiver further configured to switch from the first DCI/TCI scheme to the second DCI/TCI scheme to receive an allocation of resources for receiving PDSCH transmissions from the multiple TRPs, wherein the first DCI/TCI scheme is a hierarchical-DCI/TCI scheme, and the second DCI/TCI scheme is a hybrid-DCI/TCI scheme.

10. (canceled)

11. The WTRU of claim 9, wherein the hierarchical-DCI/TCI scheme includes the WTRU: decoding a primary PDCCH (pPDCCH) transmission from one TRP of the multiple TRPs, obtaining common resource allocations for TRPs of the multiple TRPs, decoding secondary PDCCH (sPDCCH) transmissions and obtaining different TCIs for different TRPs, and detecting a PDSCH transmission using a common resource allocation (CRA) and beams indicated by the different TCIs for different TRPs of the multiple TRPs.

12. The WTRU of claim 9, wherein the hybrid-DCI/TCI scheme includes the WTRU: decoding a group PDCCH (gPDCCH) transmission from one TRP of the multiple TRPs, obtaining common resource allocations (CRA) and different TCIs for a TRP group, decoding a gPDCCH transmission from multiple TRP groups and obtaining different TCIs for TRPs, and detecting a PDSCH transmission using CRA per group of TRPs and different beams indicated by the different TCIs for the group of TRPs.

13. The WTRU of claim 9, wherein the processor and receiver are configured to switch from the first DCI/TCI scheme to the second DCI/TCI scheme is based on a MAC CE.

14. The WTRU of claim 9, wherein the first DCI/TCI scheme is a multi-DCI/TCI scheme.

15. The WTRU of claim 9, wherein the first DCI/TCI scheme is a single-DCI scheme.
